(19) United States
(12) Patent Application Publication
(10) Pub. No.: US 2003/0096603 A1
(43) Pub. Date: May 22, 2003

(54) Wireless detachable conference telephone

(75) Inventor: Tonny Chen, Chang-Hua (TW)

Correspondence Address: DOUGHERTY & TROXELL, SUITE 1404, 5205 LEESBURG PIKE, FALLS CHURCH, VA, 22041, US

(73) Assignee: E-Lead Electronic Co., Ltd.

(21) Appl. No.: 09/988,163

(22) Filed: Nov. 19, 2001

(51) Int. Cl. H04M 3/42

(52) U.S. Cl. 455/416; 455/414

(57) ABSTRACT

A wireless detachable conference telephone and particularly a conference telephone that has a plurality of wireless microphone seats detachable from a conference telephone main body. The conference telephone main body and the wireless microphone seats may be communicated through radio signals so that users can detach the microphone seats from the conference telephone main body and move the microphone seats closely to input audio voice so that poor conversation quality resulting from distant conference telephone may be prevented from happening.

### BACKGROUND OF THE INVENTION

1. Field of the Invention

The invention relates to a wireless detachable conference telephone and particularly a conference telephone that has wireless microphones which are detachable from the telephone main body to allow users close to the wireless microphones to get improved audio input and to prevent poor audio receiving resulting from long distance between meeting participants and the microphones.

2. Description of the Prior Art

The rapid developments of business franchises and enterprise groups have created a great challenge to communication in the enterprises. For instance, to gather people from remote branches and offices to the corporate headquarter or regional head offices for meetings is time consuming and costly. The effect is also dubious. To overcome the problems of conducting meetings for remote locations, conference telephone 1 (as shown in FIG. 1) has been developed and introduced. Using this facility to connect telephone lines, people at remote locations or offices can participate meetings or conferences without physically going to the head office. This type of teleconference generally has the conference telephone 1 located at the center of a conference table. The conference telephone 1 has a plurality of microphones 11, 12 and 13 to receive the speaking voices of the participants. While such a facility may resolve some of the problems set forth above, it often happens that the conference telephone 1 cannot receive the speaking voice properly because of the microphones are located at a distance from the speakers. Participants often have to repeat the speaking or raise the voices, or try to get closer to the microphones 11, 12, 13 to get their voices clearly heard and received. As a result, the proceeding and effectiveness of the meeting is severely compromised or impaired.

As the distance between the participants and microphones is the main factor that causes undesirable telephone receiving, employing wireless detachable microphone seats to separate from the telephone body allows participants to speak to the microphones closely wherever they sit and can resolve the poor conversation quality problem incurred to the conventional conference telephones.

### SUMMARY OF THE INVENTION

The primary object of the invention is to provide a wireless detachable conference telephone that mainly includes wireless microphone seats detachable from the conference telephone main body so that the microphone seats can be moved closely to participants to facilitate users' speaking operations and achieve a better conversation quality for the conference telephone.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional conference telephone.

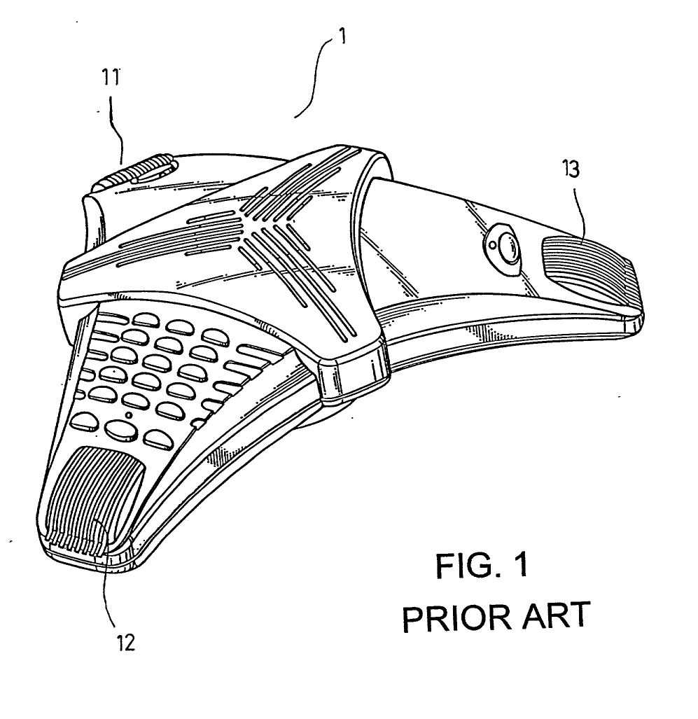

FIG. 2 is a perspective view of an embodiment of the invention.

FIG. 3 is a block diagram of a first radio unit housed in the conference telephone of the invention.

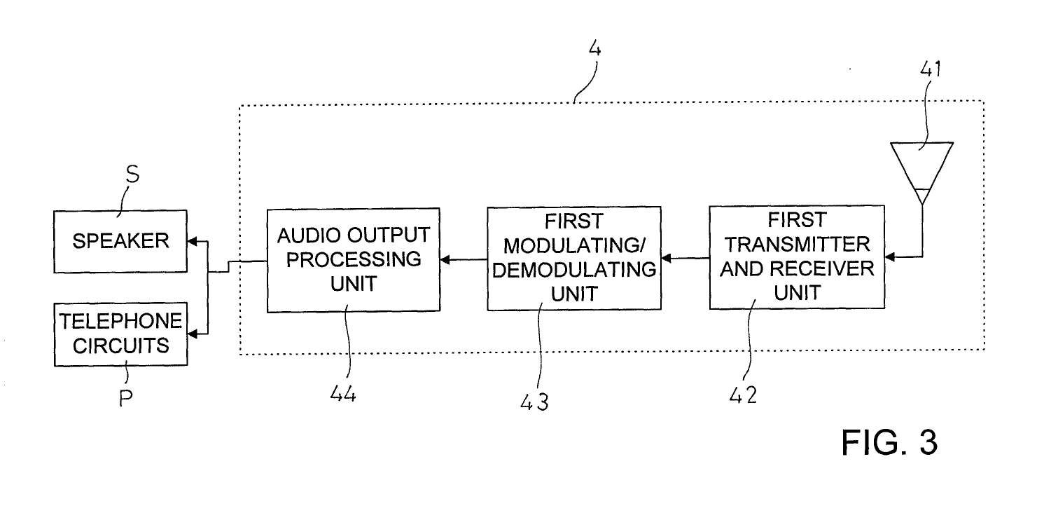

FIG. 4 is a block diagram of a second radio unit housed in the microphone seat of the invention.

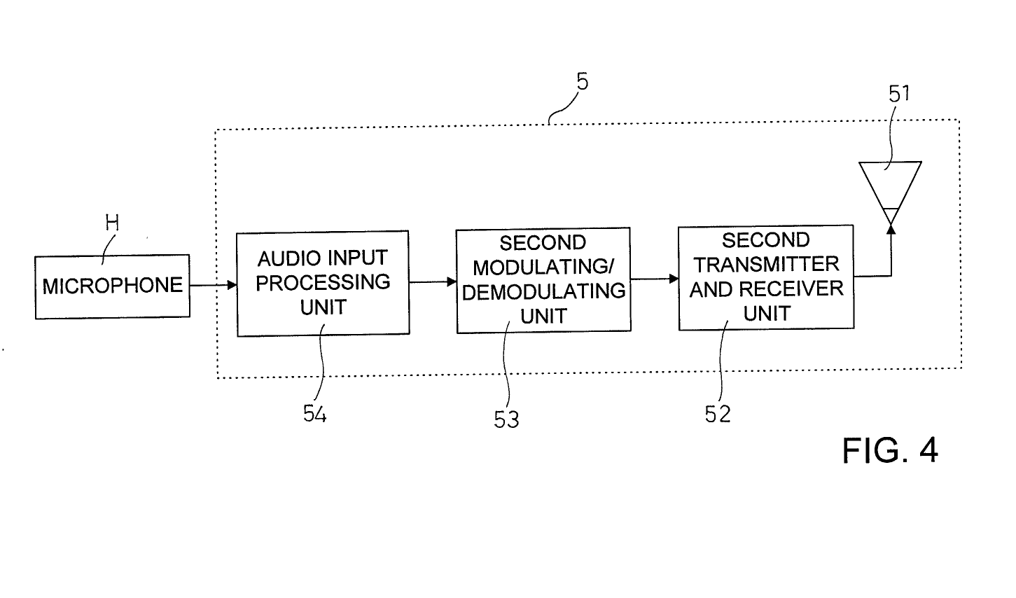

### DESCRIPTION OF THE PREFERRED EMBODIMENT

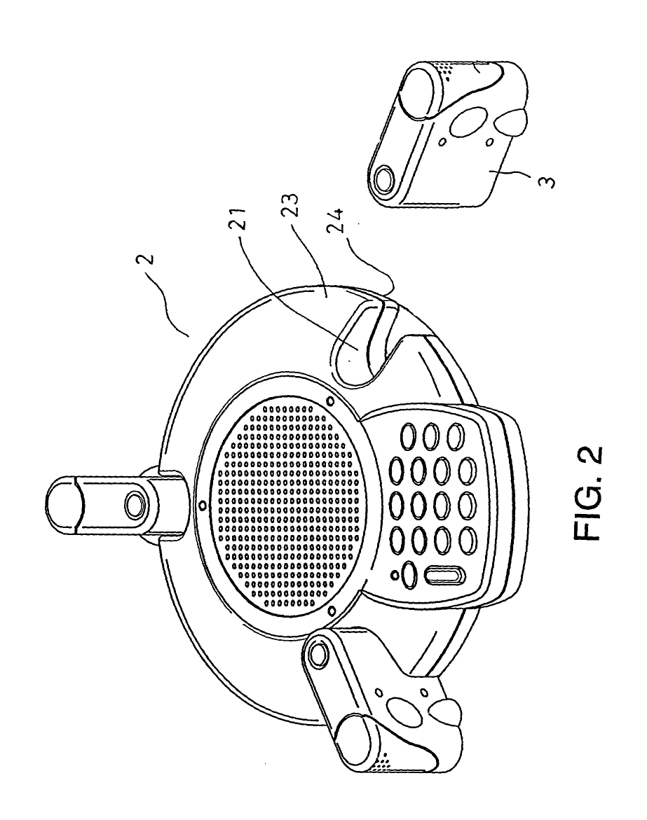

Referring to FIG. 2, the invention mainly includes a conference telephone main body 2 coupling with at least one wireless microphone seat 3. The main body 2 has an interior space for housing required circuits and at least one housing chamber 21 formed on the peripheral rim to hold and anchor the matching wireless microphone seat 3. The circuits in the conference telephone main body 2 include a first radio unit 4 to communicate with a second radio unit 5 located in the wireless microphone seat 3 for transmission and receiving radio signals therebetween. Hence the wireless microphone seat 3 may be detached from the conference telephone main body 2 and moved closer to speakers at remote locations to get better audio transmission quality.

The conference telephone main body 2 consists of an upper casing 23 and a lower casing 24 to house related circuits therein. The circuits include at least a speaker, a human machine interface (switch), telephone lines, etc. At the peripheral rim of the main body 2, there is at least one housing chamber 21 for anchoring and holding the wireless microphone seat 3. Inside the conference telephone main body 2, there is a first radio unit 4 which may communicate with a second radio unit 5 located in the wireless microphone seat 3 for transmission and receiving radio signals.

The first radio unit 4 consists of a first antenna 41, a first transmitter and receiver unit 42, a first modulating/demodulating unit 43, and an audio output processing unit 44; wherein

the first antenna 41 is for the first transmitter and receiver unit 42 to transmit or receive radio signals;

the first transmitter and receiver unit 42 transfers signals to radio waves for emission through the first antenna 41 or to receive selected radio signals through the first antenna 41;

the first modulating/demodulating unit 43 modulates or demodulates the signals and forwards the signals to the rear end first transmitter and receiver unit 42 or the audio output processing unit 44 for use; and

the audio output processing unit 44 has an output linking to a speaker S and telephone circuits P for processing the modulated audio signals, and outputting through the speaker S and telephone circuits P.

The second radio unit 5 consists of a second antenna 51, a second transmitter and receiver unit 52, a second modulating/demodulating unit 53, and an audio input processing unit 54; wherein

the second antenna 51 is for the second transmitter and receiver unit 52 to transmit or receive radio signals;

the second transmitter and receiver unit 52 transfers signals to radio waves for emission through the second antenna 51 or to receive selected radio signals through the second antenna 51;

the second modulating/demodulating unit 53 modulates or demodulates the signals and forwards the signals to the rear end second transmitter and receiver unit 52 for use; and

the audio input processing unit 54 has an input linking to a microphone H for modulating audio signals input by users and forwarding to the second modulating/demodulating unit 53 for use.

By means of the construction set forth above, users may move the wireless microphone seats 3 away from the conference telephone main body 2 at a distance closer to the users to make better quality conversation and to overcome the disadvantages of the conventional conference telephones.

The operation of the invention is as follows:

A. For the wireless microphone seats 3:

1. users input audio voice through the wireless microphone seats 3;

2. the input audio voice is processed by the audio input processing unit 54 for removing echoes, noises, etc.;

3. the input audio voice is modulated by the second modulating/demodulating unit 53;

4. the modulated audio voice is transferred to radio signals through the second transmitter and receiver unit 52, and is transmitted through the second antenna 51 to the first radio unit 4 in the conference telephone main body 2 for receiving.

B. For the conference telephone main body:

1. the first transmitter and receiver unit 42 receives radio signals from the wireless microphone seats 3 through the first antenna 41;

2. the wireless microphone seats 3 receive the signals and transmit to the first modulating/demodulating unit 43 for demodulating;

3. the first modulating/demodulating unit 43 transmits the demodulated audio signals to the audio output processing unit 44;

4. the audio output processing unit 44 receives signals from the first modulating/demodulating unit 43 and removes echoes, noises, etc., and through the circuits in the conference telephone main body 2 outputs audio sound through the speaker S and telephone circuits P.

In summary, the invention provides wireless microphone seats that are detachable from the conference telephone main body so that users can be close to the microphones to obtain good conversation quality to ensure teleconference will be conducted smoothly and conveniently, and to prevent poor quality conversation caused by long distance of users from the microphones.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A wireless detachable conference telephone, comprising:
a conference telephone main body having at least one housing chamber formed on the peripheral rim thereof and a first radio unit located therein; and
at least one microphone seat movably housed in the housing chamber having a second radio unit to communicate with the first radio unit for transmitting and receiving radio signals therebetween.

2. The wireless detachable conference telephone of claim 1, wherein the first radio unit includes a first antenna, a first transmitter and receiver unit, a first modulating/demodulating unit, and an audio output processing unit;
the first antenna being for the first transmitter and receiver unit to transmit or receive the radio signals;
the first transmitter and receiver unit transferring signals to radio waves for emitting through the first antenna or receiving selected radio signals through the first antenna;
the first modulating/demodulating unit modulating or demodulating the signals and forwarding the signals to the rear end first transmitter and receiver unit or the audio output processing unit for use; and
the audio output processing unit having an output linking to a speaker and telephone circuits for processing the modulated audio signals, and outputting through the speaker and the telephone circuits.

3. The wireless detachable conference telephone of claim 1, wherein second radio unit includes a second antenna, a second transmitter and receiver unit, a second modulating/demodulating unit, and an audio input processing unit;
the second antenna being for the second transmitter and receiver unit to transmit or receive the radio signals;
the second transmitter and receiver unit transferring signals to radio waves for emitting through the second antenna or receiving selected radio signals through the second antenna;
the second modulating/demodulating unit modulating or demodulating signals and forwarding the signals to the second transmitter and receiver unit for use; and
the audio input processing unit having an input linking to a microphone for modulating audio signals input by users and forwarding to the rear end second modulating/demodulating unit for use.
